(19) United States
(12) Patent Application Publication
(10) Pub. No.: US 2006/0126742 A1
(43) Pub. Date: Jun. 15, 2006

(54) Method for optimal transcoding

(75) Inventors: Ziv Soferman, Givatayim (IL); Yohai Falik, Rananna (IL)

Correspondence Address: TIAJOLOFF & KELLY, CHRYSLER BUILDING, 37TH FLOOR, 405 LEXINGTON AVENUE, NEW YORK, NY, 10174, US

(73) Assignee: Adamind Ltd., Ra'anana (IL)

(21) Appl. No.: 11/299,204

(22) Filed: Dec. 9, 2005

Related U.S. Application Data
(60) Provisional application No. 60/634,550, filed on Dec. 10, 2004.

(51) Int. Cl. H04N 11/02; H04N 7/12; H04B 1/66; H04N 11/04

(52) U.S. Cl. 375/240.16

(57) ABSTRACT

A method for transcoding a plurality of media items by allocation of processing power and storage through a combination of pre-processing the media item and processing in real time to provide transcoding of the plurality of media items. The method includes receiving information that relates to the computational and storage capabilities available for transcoding. The information received includes available power, available storage, variants to which to transcode and at least one of the respective probability and importance of the variants. The method also includes determining how to pre-process the plurality of media items in response to the received information, such that the transcoding is optimized.

### CROSS REFERENCE TO RELATED APPLICATION

This application claims priority from U.S. Provisional Patent Application No. 60/634,550, filed Dec. 10, 2004, which is hereby incorporated by reference in its entirety.

### FIELD OF THE INVENTION

The present invention generally relates to a method for providing transcoding hardware of various types, and in particular to a method for providing efficient memory and computational resources for transcoding hardware.

### BACKGROUND OF THE INVENTION

Transcoding operations are needed wherever a media item is transmitted in a first format, at a bit rate and/or frame rate to be received by a device, wherein the media item is adapted to be received in another format, bit rate and/or frame rate. The receiving device may be a handset, a computer, TV set, etc.

Typically, a transcoding server is positioned between the transmitter and the receiving party.

There are two typical approaches to transcoding. The first involves transcoding by the transcoding server, while the second approach involves off loading the transcoding server. The first approach involves transcoding and encoding the media item by the transcoding server, in real time. When one server provides for a number of users simultaneously, that may result in a heavy computational load that may require strong and usually costly computational capabilities.

The second approach involves pre-processing the media item. This may include performing transcoding of the media item in advance (not in real time), according to at least one most anticipated transcoding variant. This may require a large or very large amount of storage, especially when multiple transcoded versions of a media item are generated.

The first approach requires powerful CPU's, as well as relatively modest storage capabilities, while the second approach requires very large storage and a modest CPU.

In many cases the transcoding hardware does not fit either of the above mentioned requirements. For example, it may include a large, but not sufficiently large storage means and have a powerful but not sufficiently powerful processing capability. This will not allow operation according to either of the above two options. If the large storage option is taken, and there is a strong CPU, the CPU may not be used to full capacity.

Thus, there is a need to provide a method and a system for preprocessing of media items determined in response to the system transcoding computational and storage capabilities.

### SUMMARY OF THE INVENTION

Accordingly, it is a principal object of the present invention to provide efficient memory and computational resources of transcoding hardware of various types, including transcoding hardware that does not match the requirements of the two prior art transcoding approaches.

It is another principal object of the present invention to provide various embodiments, so that the amount of preprocessing is determined in response to the system transcoding computational and storage capabilities.

It is one other principal object of the present invention that characteristics of the transcoding operation are enabled, rather than simply being another implementation of a partial-realtime-processing, partial-pre-processing approach to the storage-CPU requirement tradeoff. This approach responds well to peaks in demand, and avoids the latency penalty in addition to saving CPU requirements.

A method is disclosed for transcoding a plurality of media items by allocation of processing power and storage through a combination of pre-processing the media item and processing in real time to provide transcoding of the plurality of media items. The method includes receiving information that relates to the computational and storage capabilities available for transcoding. The information received includes available power, available storage, variants to which to transcode and at least one of the respective probability and importance of the variants. The method also includes determining how to pre-process the plurality of media items in response to the received information, such that the transcoding is optimized.

According to one exemplary embodiment of the invention, a time division or pipeline approach is provided. A certain segment of the media item is pre-processed in advance. While this pre-processed item is streamed/transmitted, another segment of the media item is transcoded in realtime. In this way, the user experiences streaming and real time transcoding, while only the second part of the multimedia (MM) item is actually transcoded in real time. The length of the transcoded segment is responsive to the capabilities of the transcoding entity, as well as to additional parameters such as the identity (and amount) of transcoded variants.

According to principles of the present invention, results may be stored during pre-processing. In many embodiments, the pre-processing stage refers to storage of results from a realtime on-demand transcoding operation for additional future use, whereas realtime connotes discarding such results after use.

The above approach allows storage of a pre-processed segment, thus reducing the overall memory consumption and reduces the real time computational load.

The identity of transcoded variants may be determined in advance and may be updated during the transmission session. The selection of which variants to generate may be responsive to its demand probability. This probability can be estimated by the popularity of the various handsets in the market, and by a learning process based on the user's choices and preferences.

Various methods can be implemented for determining which variant to select. They can take into account the utilization of the transcoding system resources, including penalties for “missed” events that require extensive real time transcoding of variants that were not pre-processed earlier. In a typical scenario the variants most expected to be demanded will be generated in advance.

According to an alternative embodiment of the present invention the pre-processing is allocated to tasks that require measurable computational resources. This is referred to as a partial pre-processing approach. Thus, instead of processing entire segments of the media item on a realtime basis, the pre-processing involves partial processing of the media stream.

For example, each stage in the transcoding process is assigned a value or flag that indicates the computation and/or storage requirements of the stage. In response to the value of the flags, it is determined whether to perform this stage in advance or in real time.

For example, the process does store variant components for which the flag value is high and does not store (process in real time) those components for which this saving value is low. E.g., in compression of video by MPEG-2 or MPEG-4 standards, as with many other encoding schemes, there is motion information, and a discrete cosine transform (DCT) calculation is performed on the difference between the actual block/macroblock to be encoded and the predicted block/macroblock. The motion information is the most time consuming, but it takes a relatively low amount of storage to save it. So, it is worthwhile to store this information which results from pre-processing, but leave the DCT calculation to real time processing. In this example, the fully pre-processed variant and its first part are not stored, but only the motion information.

According to another alternative embodiment of the present invention the time division approach and the partial pre-processing approach can be combined. For example, the process can first determine which segment of the media item to pre-process and then apply partial pre-processing.

According to various alternative embodiments the present invention may involve at least one of the following schemes:
1. The entire variant is transcoded in real time. No pre-processing and no storing take place;
2. Part of the variant is pre-processed or “pre-transcoded.” In this case the first part is fully transcoded and stored in memory. In this way there will be real time transcoding, but only of the part which was not pre-transcoded. The pre-transcoded part is ready for streaming.
3. Hints are provided. I.e., all or part of the variant is transcoded.

However, the result is not stored in its final version, ready for streaming, but a compressed representation of the result, such as motion information, is stored. This is efficient because of the saving in processing time relative to the amount of storage required. This means e.g., that let say after transcoding, only 20% is stored in terms of motion info. Later on when it comes to streaming, it cannot be streamed as it is, but has to add some relatively low amount of computation to prepare it for streaming. This computation is reserved for real time.

Additional features and advantages of the invention will become apparent from the drawings and descriptions contained herein below.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a flow chart of an exemplary method for pre-processing a media item for optimal allocation of processing power and storage, constructed according to an exemplary embodiment of the present invention;

FIG. 2 is a flow chart for deciding whether to “pre-process” the output media (e.g. video), by storing it entirely, storing its hint information or storing nothing, according to an exemplary embodiment of the present invention;

FIG. 3 is a graph displaying the relative cost in storage and realtime CPU resources for three different approaches, according to alternative embodiments of the present invention; and

FIG. 4 is a graph displaying the parameters of FIG. 3, wherein the available options per media are either full pre-process and storage or computation in realtime, according to one exemplary embodiment of the present invention.

### DETAILED DESCRIPTION OF AN EXEMPLARY EMBODIMENT

The principles and operation of a method and a system according to the present invention may be better understood with reference to the drawings and the accompanying description, it being understood that these drawings are given for illustrative purposes only and are not meant to be limiting.

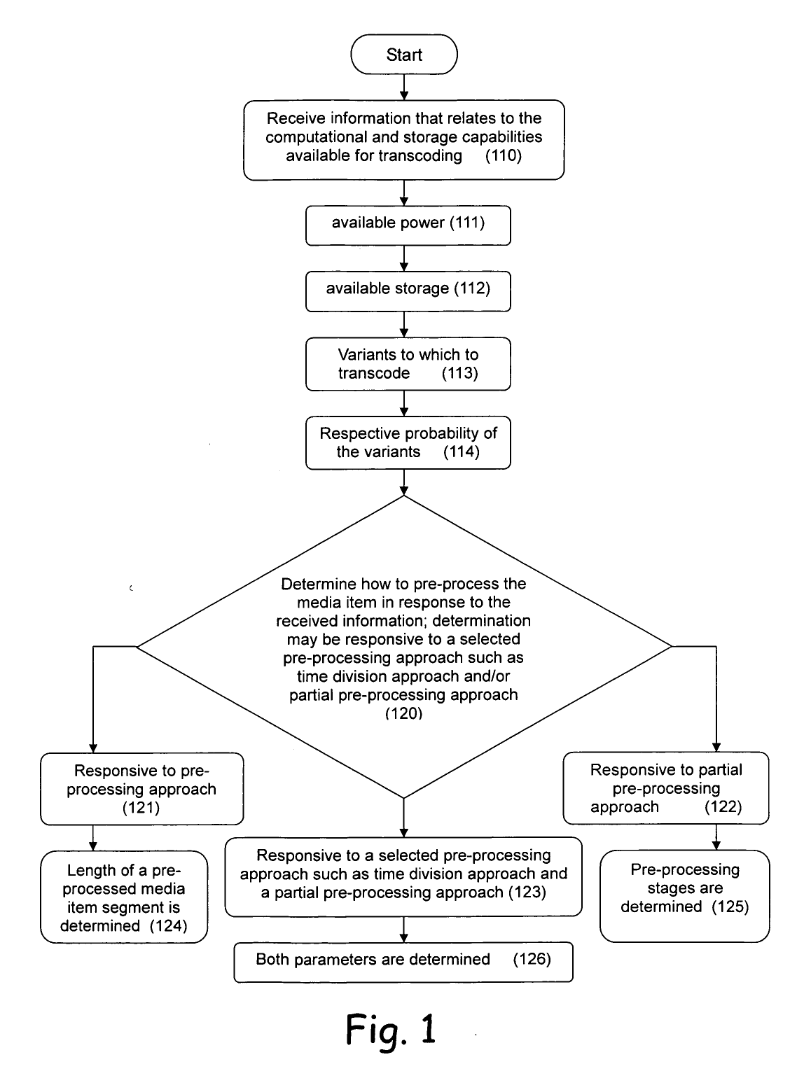

FIG. 1 is a flow chart of an exemplary method 100 for pre-processing a media item for optimal allocation of processing power and storage, constructed according to an exemplary embodiment of the present invention. This method followed by processing the media item in real time to provide a transcoded media item.

Method 100 starts by receiving information that relates to the computational and storage capabilities available for transcoding 110. Information received includes available power 111, available storage 112, variants to which to transcode 113 and the respective probability or importance of said variants 114. Step 110 may also include receiving information relating to transcoding variants and their demand probability and/or importance. This may include information relating to the resources required to process and/or store each variant.

Step 110 is followed by step 120, wherein it is determined how to pre-process the media item, in response to the received information. The determination may be responsive to a selected pre-processing approach, such as a time division approach 121 or a partial pre-processing approach 122 or a combination of both 123. If the first approach is selected the length of a pre-processed media item segment is determined 124. If the second approach is determined the pre-processing stages are determined 125. If a hybrid approach is selected both parameters are determined 126. Step 120 may involve calculating a cost function to provide optimal performances. Two other alternative implementations of step 120 are the extremes: full pre-processing and no pre-processing.

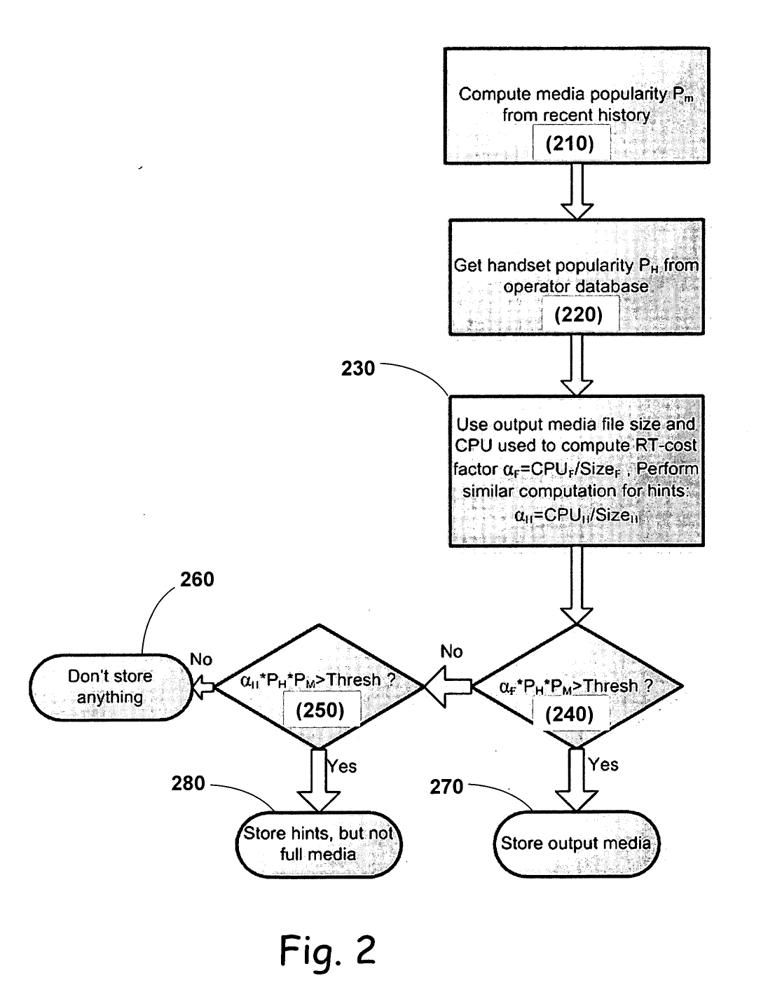

FIG. 2 is a flow chart for deciding whether to store (“pre-process”) the output media (e.g. video), its hint information or nothing, according to an exemplary embodiment of the present invention. First compute the media popularity Pₘ from recent history 210 and then get the handset popularity P_{H} from the operator database 220. Next use the output media file size and the CPU to compute the realtime (RT)-cost factor α_{F}=CPU_{F}/Size_{F}, and perform a similar computation for the hints: α_{H}=CPU_{H}/Size_{H} 230. If α_{F}*P_{H}*P_{M}>Thresh 240, then store the output media 270. If α_{H}*P_{H}*P_{M}>Thresh 250, then store the hints, but not the full media 280, and if neither is true, then do not store anything 260.

This is an embodiment in which the video clips are not pre-processed in advance, but may be stored for subsequent usage, similar to the use of advance pre-processing. This variant uses the following features:

Partial storage, including hints (i.e. information requiring a big portion of the overall CPU pre-transcoding, and much less storage, e.g. motion-estimation vectors); and

Different handling of different media-handset combinations according to their expected frequency. There is also different handling according to the ratio between CPU and storage consumption. Note: The probability model assumes independence between the output media (video clip) and handset (i.e. P(clip-m, handset-h) =P(clip-m)*P(handset-h)). Other models are also possible. Note: In this embodiment there is also a get workflow, using pre-transcoded media, hints+additional processing, or realtime transcoding, according to availability−this is obvious. There may also be a periodic clean-up process, removing unused media from the storage. This is actually the same workflow with minor variations for each saved media.

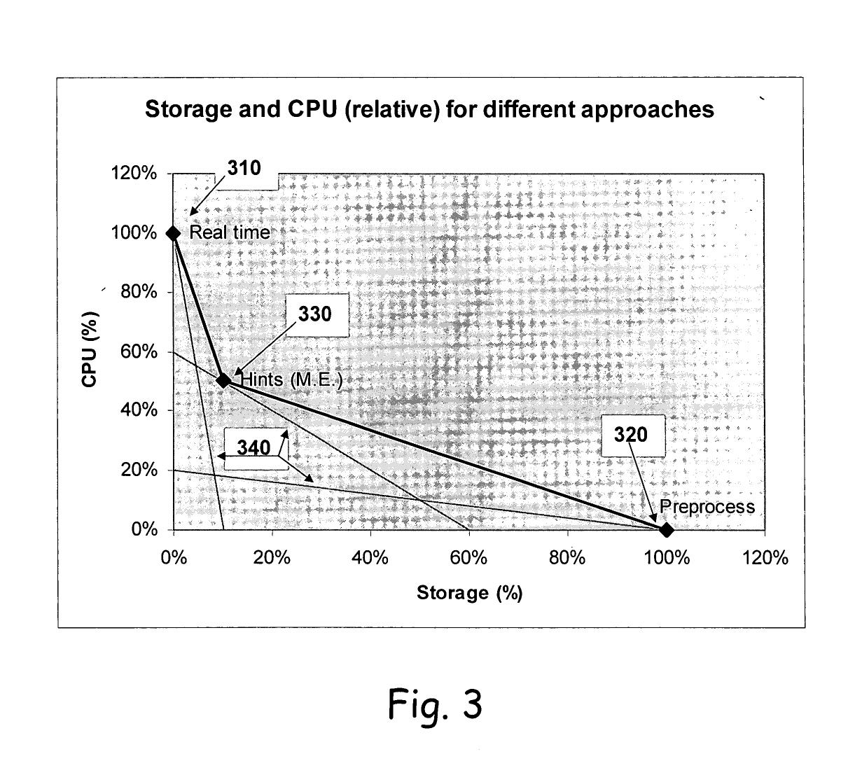

FIG. 3 is a graph displaying the relative cost in storage and realtime CPU resources for three different approaches, according to an exemplary embodiment of the present invention: Just realtime 310; full pre-processing and storage 320; and storage of hints and realtime computation using this information 330. For hints of type motion-estimation (ME) 330, their computation typically requires ˜60% of the encoding, i.e. ˜50% of the decode-encode (using full-search on ME vectors, this figure may reach 95%). The typical storage required for this information is 20% of the output media encoded in low bit rate (strong compression) and 5% of the high bit rate version. The value used in the graph was 50% CPU, 10% storage. The graph also includes three lines representing different cost functions 340—for each a different balance between realtime CPU and storage is optimal.

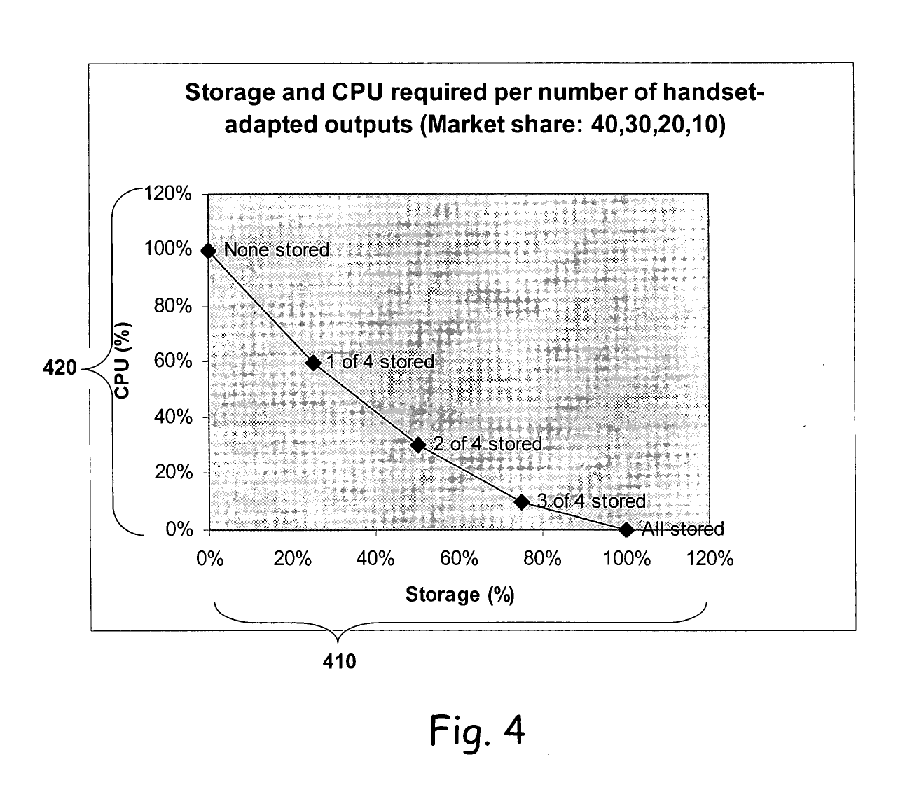

For each variant the overall optimization space chooses the amount of preprocessing to be done (X % of CPU, Y % of storage) according to its probability and according to the global dynamic cost function. This is a multidimensional function and can be best visualized by two selected views. FIG. 3, described above, focuses on a per-variant view, and for simplicity considers just the three pre-processing options: none, partial-ME and full. FIG. 4 complements FIG. 3 by considering for two such options, applying the more storage-consuming of the two to the X % most popular variants. For simplicity, it depends just on the handset.

These cost functions may be dynamic and use other information such as the frequency of different media and handsets, etc.

FIG. 4 is a graph displaying the parameters of FIG. 3, wherein the available options for each of the output media are either full pre-process and storage 410, or computation in realtime 420, according to an exemplary embodiment of the present invention. Four groups of handsets are assumed (according to transcoding parameters), with market segments of 40%, 30%, 20% and 10%. It is assumed that transcoding time and output media size are equal for all handsets, and there is no knowledge of the popularity of different media.

The Objective (Cost) Function and the Optimization

The method described above is invariant or transparent to the actual cost function. The cost function is used to define what is to be considered optimal. This freedom includes the freedom of what parameters to use e.g., the probability of a variant to be demanded, etc.

Given a set of multimedia (MM) items, with possible variants for each item, and a given total amount of storage for storing all the preprocessed variants, or parts of variants. As mentioned above, it is possible that a first part of a variant will be pre-processed and its second part will be transcoded in realtime.

The goal of the optimization is to select which variants of the MM items and what part of each variant will be preprocessed, so as to fill a certain amount of storage dedicated for preprocessed variants. Alternatively, the total amount of storage dedicated for preprocessed variants or their parts may not be fixed, but may depend on some increasing “cost” associated with increasing occupation of storage. The above selection is done in view of a chosen cost function which defines what criterion or what magnitude will be optimized when selecting with which pre-processed variants to fill the storage.

Processed variants may be stored by their respective “hints” rather than the streaming-ready version. To build examples for cost functions, consider the following mathematical definitions and generic terms to be used in the cost functions:

### DEFINITIONS

Variant—is the pair of the multimedia item and the display capabilities (handset family) for a specific representation of a MM item, e.g., the format, resolution, compression level or bandwidth needed to stream it, etc.

Format—refers to file-format, codec: a characterization of the representation of the variant, which describes the variant form for a given content/structure. For example: color; space; bit/pixel; compression level; size; resolution; etc.

Let P(i) be the probability of a variant i (counting all the variants of all items by the index i) to be demanded;

L(i)—size of variant i after transcoding;

T(i)—transcoding time of entire variant I;

ALPHA(i)—the relative size (fractional size) of the first part of variant I, which is to be pre-processed and stored; and

HINTSIZE(i)—the size of variant 1, when represented as a hint only. This can be approximated by HINTSIZE(i)=L(i)*FACTOR, where FACTOR is the average factor of size reduction of a variant, should it be represented by Its hints. In case the entire variant is not stored, the hint size will be obtained by multiplying by the factor ALPHA(i). Thus for pre-transcoding of the first part of the variant: HINTSIZE(i)=L(i)*ALPHA(i)*FACTOR

Hint_processing_time=HINTSIZE(i)*Processing_time_factor, where Processing_time_factor is the time it takes to process the hint to complete the transcoding/size of the hint.

The expected saving in realtime processing time due to preprocessing and storing of a certain variant i in a streaming-ready version is:

T_save(i)=ALPHA(i)*T(i), i.e., the time it would take to transcode the entire variant multiplied by the fraction indicating the relative size of the pretranscoded part to the entire variant size.

T_saving=Sum over i=1, . . . , N of {P(i)*ALPHA(i)*Ti}, i.e., the expected value of total saving in realtime transcoding from pre-transcoding parts of all the variants.

The optimization of T_saving as a cost function is derived as follows: Define a new variable “specific_saving”, which measures the expected time saved per each bit stored of the variant i.

Specific_saving(i)=[T(i)/L(i)]*P(i). T(i)/L(i) is the processing time saved on the average per bit of the variant I, should it be preprocessed and stored. [T(i)/L(i)]*P(i) is the expected processing time saved by storing one bit of variant i, considering the probability for demand of variant i, the expected processing time saved per bit of variant i becomes [T(i)/L(i)]*Pi.

Penalty value: sometimes, the inability to transcode a demanded variant in real time may cause problems, and a penalty value may be used to express it.

The mathematical problem is to solve for the values of ALPHA(i), while optimizing the cost function. Since the values of the ALPHA(i)'s may vary between 0 and 1, all those variants whose respective ALPHA(i)'s are zero are actually not preprocessed at all, and only those with ALPHA(i)'s>0 are preprocessed. In that sense, the optimization process “decides” which variants to preprocess at all, and can be said to prioritize which variants are going to be preprocessed at all. The prioritization is mentioned here, since the algorithm to solve the optimization problem can be simplified if it proceeds in the order resulting from sorting.

Examples of optimizing cost functions:

1. The total realtime computation time saved by pre-processing and storing variants or their parts in a given amount of dedicated storage:

T_saving =Sum over I=1, . . . , N of {P(i)*ALPHA(i)*T(i)}, subject to:

Total_storage_used=constant (i.e. size of dedicated storage)

where: Total_storage_used=Sum over i=1, . . . , N of {ALPHA(i)*L(i)}

2. The total realtime processing time saved as before, but when the amount of dedicated storage is not a constant, and there is a “penalty” for going above a certain storage size, or, more generally, a “payment” for storage size from zero amount of storage and up:

Cost=T_saving+PAY(Total_storage_used),

Where: T_saving and Total_storage_used are as above, PAY is the function (with negative values) indicating a “payment” to be exacted for storage consumption.

3. The “hint,” or partial information, can be applied as well in the cost function: Then the total processing time in real time that is saved is: T_saving=Sum over i=1, . . . , N of {P(i)*ALPHA(i)*T(i)}−Sum over i=1, . . . , N of {P(i)*ALPHA(i)*FACTOR*Processing time factor}, subject to:

Total_storage_used=constant (i.e. size of dedicated storage),

where: Total_storage_used=Sum over I=1, . . . , N of {ALPHA(i)*L(i)}*FACTOR.

Explanation: the time saved is not as in 1 or 2, but the realtime processing of the hints is to be added to the expected realtime processing time. Thus, if the saved time is being optimized, this hint processing time should appear with a minus sign,

where FACTOR=compression ratio, or the (the storage occupied by the hint/the amount of storage occupied by the full transcode of this item). Of course, the compression factor can be defined in respect to a part of a variant. The processing time needed for the hint to make it a streaming-ready transcoded item or item part, is:

Hint_processing_time is the size of storage occupied by the Hint*Processing_time_factor.

Processing_time_factor is the time it takes to process the hint-size of the hint. The realtime processing saved is addressed by the cost function, has to take into consideration the time it takes to process the hints into a streaming-ready variant.

4. Other cost functions can be built as desired with terms, for example, that add some penalty (negative cost) for delay in case of the need to wait until the realtime processing is finished. Such a term can result from avoiding to have ALPHA(i)'s equal to zero and to “push to” solutions with more homogeneous ALPHA(i) values. Such a term could be added to each of the above cost functions. An example for such a term is:

DELAY_TERM=-BETA′ L(i)ˆp, where 0<p<3, where p is to be chosen later by experimentation. BETA is a constant weight factor to be chosen by experimentation.

Other examples of cost functions are obtained by combinations of the above. In general, cost functions can be built from the above components, wherein the variant is divided into three rather than two parts. The first part is fully pre-transcoded, the second is pre-transcoded by hints and the third is not pre-transcoded at all. Other divisions are possible as well. The result of the optimization is, for every variant, to provide a set of coefficients indicating how to divide the variant into the various pre-transcoding modes, similarly to the full pre-transcoding and hints version.

Optimizing the Cost Functions:

Two general approaches are proposed: a specific approach for those cost functions dominated by linear terms; and a general non-linear approach, which is more time-consuming.

The Specific Approach:

1. For Each variant calculate its specific_saving_i value.

2. Optionally, sort all possible variant candidates for preprocessing according to their respective specific_saving_i value from highest to lowest.

3. Start from the variant with the highest specific saving, preprocess it and store it, until it is not possible to store any more full variants.

4. The remainder of the storage space, if any, fill with the first part of the next unstored variant. Choose the size of this first part to be preprocessed and stored, so as to entirely fill the allocated storage.

The General Approach:

Alternative and less efficient ways to perform the optimization, done off-line, are methods such as descent or conjugate gradient. These provide more non-linear cost functions, e.g., the one which involves the DELAY TERM. In case there are constraints, Lagrange multipliers, or linear programming may be the best way. The result of the optimization should be a solution for all the ALPHA(i)'s leading to the optimum.

Comments:

Other objective functions can be used as well. For example, providing a penalty term. Thus, for each variant i, the penalty value will be PENALTY(i) reflecting the delay the user suffers if the variant is not fully pre-processed.

For Example:

PENALTY(i)=T(i)−PLAYING_TIME_i is that which cannot be done during playing time. Therefore, download or progressive download are the only alternatives.

Alternatively, PENALTY(i) can reflect the subjective “irritating value” for the client, by waiting through the delay. In such cases, the expected total delay time for all variants can be calculated and the choice of the variants to be pre-processed, as well as the length of the pre-processed part and the realtime processed part, are optimized to minimize the total PENALTY.

Where a safety factor is needed, a penalty may also be applied for resource use beyond the specified threshold.

Other objective functions are possible as well.

Of course, flags can be taken into account in the same way by accounting for their respective value as a term reflecting the saving in time, vs. cost in storage, and cost in real time processing, even if much lower than real time processing ab-initio (from the start, without flags).

According to yet another embodiment of the invention the time division approach, as well as the partial pre-processing approach are combined.

### GLOSSARY

Variant—is the pair of the multimedia item and the display capabilities (handset family) for a specific representation of a MM item, e.g., the format, resolution, compression level or bandwidth needed to stream it, etc.

Format—refers to file-format, codec: a characterization of the representation of the variant, which describes the variant form for a given content/structure. For example: color; space; bit/pixel; compression level; size; resolution; etc.

Hint—partial information, whereby storing saves a relatively lot of computation. For example, in an encoded variant, the hint may be the motion information. If only the motion information is stored, it still requires more processing to create the fully encoded variant. However, the hint saves most of the computation needed to complete the encoding. So it is “efficient” to store a hint, since it occupies low storage and saves most of the computation time.

We claim:

1. A method for transcoding a plurality of media items by allocation of processing power and storage through a combination of pre-processing the media item and processing in real time to provide transcoding of the plurality of media items, the method comprising:
receiving information that relates to the computational and storage capabilities available for transcoding, the information comprising:
available power;
available storage;
variants to which to transcode; and
at least one of the respective probability and importance of said variants; and
determining how to pre-process the plurality of media items in response to the received information, such that the transcoding is optimized.

2. The method of claim 1, wherein said determining step is responsive to a selected pre-processing approach.

3. The method of claim 2, wherein said determining step comprises at least determining one of the length of a pre-processed media item segment and CPU consumption.

4. The method of claim 2, wherein said selected pre-processing approach is a time division approach.

5. The method of claim 2, wherein said selected pre-processing approach refers to storage of results from a realtime on-demand transcoding operation, for additional future use, wherein realtime connotes discarding such results after use.

6. The method of claim 5, wherein said pre-processing approach refers to partial storage at least comprises hints and thereby requires substantially less storage.

7. The method of claim 6, wherein said hints at least comprise motion-estimation vectors.

8. The method of claim 1, wherein said selected pre-processing approach is a partial pre-processing approach.

9. The method of claim 8, wherein said determining step comprises at least determining the stages of pre-processing.

10. The method of claim 1, wherein said selected pre-processing approach is a combination of a time division approach and a partial pre- processing approach.

11. The method of claim 10, wherein said determining step comprises at least determining the length of a pre-processed media item segment and the stages of pre-processing.

12. The method of claim 1, further comprising calculating a cost function.
